(19) United States
(12) Patent Application Publication
(10) Pub. No.: US 2011/0264417 A1
(43) Pub. Date: Oct. 27, 2011

(54) SPACTIAL MODELLING SYSTEM EMPLOYING BIM

(76) Inventors: Jin Won Choi, Seoul (KR); Lertlakkhanakul Jumphon, Seoul (KR); Doo Young Kwon, Gyeonggi-do (KR)

(21) Appl. No.: 13/142,198

(22) PCT Filed: Dec. 4, 2009
(86) PCT No.: PCT/KR09/07233

§ 371 Date: Jun. 24, 2011

(30) Foreign Application Priority Data
Dec. 24, 2008 (KR) 10-2008-0133640

(51) Int. Cl. G06F 17/50

(52) U.S. Cl. 703/1

(57) ABSTRACT

Disclosed is a spatial modelling system. The spatial modelling system comprises: a modelling module for generating modelling information about a space in accordance with input from a user; a space syntax module for perceiving the space on the basis of the modelling information generated by the modelling module, and generating information about the space syntax of at least one portion of the space; and a control module for displaying the results of an analysis of the space syntax of the at least one portion of the space, on the basis of information about the space syntax obtained by analysis by means of the space syntax module.

### TECHNICAL FIELD

Exemplary embodiments of the present invention relate to a spatial modelling system based on Building Information Modelling (BIM) scheme and, more particularly, to a spatial modelling system that effectively models a space by analyzing space syntax simultaneously while modelling the space.

### BACKGROUND ART

Recently, diverse researches are conducted for efficient space, such as Building Information Modelling (BIM). Among them is a study on space syntax.

Space syntax is one of architectural space analysis methods, which perceives each component constituting a space as an independent unit element and analyzes the relationship between the constituent components. Since the space syntax can represent the properties of a particular space of a global area in the form of objective numbers or graph, the space syntax may be usefully used for analyzing a space and if there is any problem, remodelling the space.

According to conventional space syntax analysis methods, a person himself has to analyze information on a space, or a person may acquire an analysis result as a result of all the labor of re-inputting all constituent components of the information on the space, such as lines, points, and other objects, one by one so that a predetermined space syntax analysis tool could perceive the information on the space.

The conventional space syntax methods, however, have a drawback that a work of modelling a space and a work of analyzing the syntax of the space are performed independently from each other.

Therefore, it is required to develop a system that may model a space and analyze the space syntax of the modelled space simultaneously so as to efficiently model and design the space according to a purpose based on the space syntax analysis result.

### DISCLOSURE

### Technical Problem

An embodiment of the present invention is directed to a spatial modelling system that not only generates modelling information of a space simply but also perceives the generated space, too, simultaneously so as to make a user efficiently design the space according to the purpose of the space.

In accordance with an embodiment of the present invention, a spatial modelling system includes: a modelling module configured to generate modelling information of a space based on input data inputted by a user; a space syntax module configured to perceive the space based on the modelling information generated by the modelling module, and generate information on space syntax of at least a portion of the space; and a control module configured to display a space syntax analysis result of the at least one portion of the space based on the information on space syntax obtained from analysis in the space syntax module.

The information on space syntax may include at least one selected from the group consisting of connectivity, control value, depth, integration, and intelligibility.

The control module may display the space syntax analysis result to have different display attributes according to a value of the information on space syntax.

The display attributes comprise color.

### BRIEF DESCRIPTION OF THE DRAWINGS

Brief descriptions on the drawings are provided herein to help sufficiently understand the drawings referred to in the detailed description of the present invention.

FIG. 1 is a functional block diagram illustrating a spatial modelling system in accordance with an embodiment of the present invention.

FIGS. 2 to 7 illustrate information on space syntax obtained from the analysis of the spatial modelling system in accordance with the embodiment of the present invention.

FIG. 8 exemplarily shows screen images obtained after performing a modelling operation in the spatial modelling system in accordance with the embodiment of the present invention.

FIG. 9 illustrates a process of analyzing a space based on space syntax in a spatial modelling system in accordance with an embodiment of the present invention.

### BEST MODE FOR THE INVENTION

Exemplary embodiments of the present invention will be described below in more detail with reference to the accompanying drawings to help understand the technology, advantage, and purposes of the present invention.

Also, when any one constituent element in the present specification transmits data to another constituent element, the constituent element may directly transfer the data to another constituent element, or transmit the data to another constituent element through at least one yet another constituent element.

Conversely, in a case where any one constituent element in the present specification ‘directly transmits’ data to another constituent element, it means that the constituent element directly transmits the data to another constituent element without passing through yet another constituent element.

Hereafter, embodiments of the present invention are described in detail with reference to the accompanying drawings. The same reference numeral is given to the same constituent element.

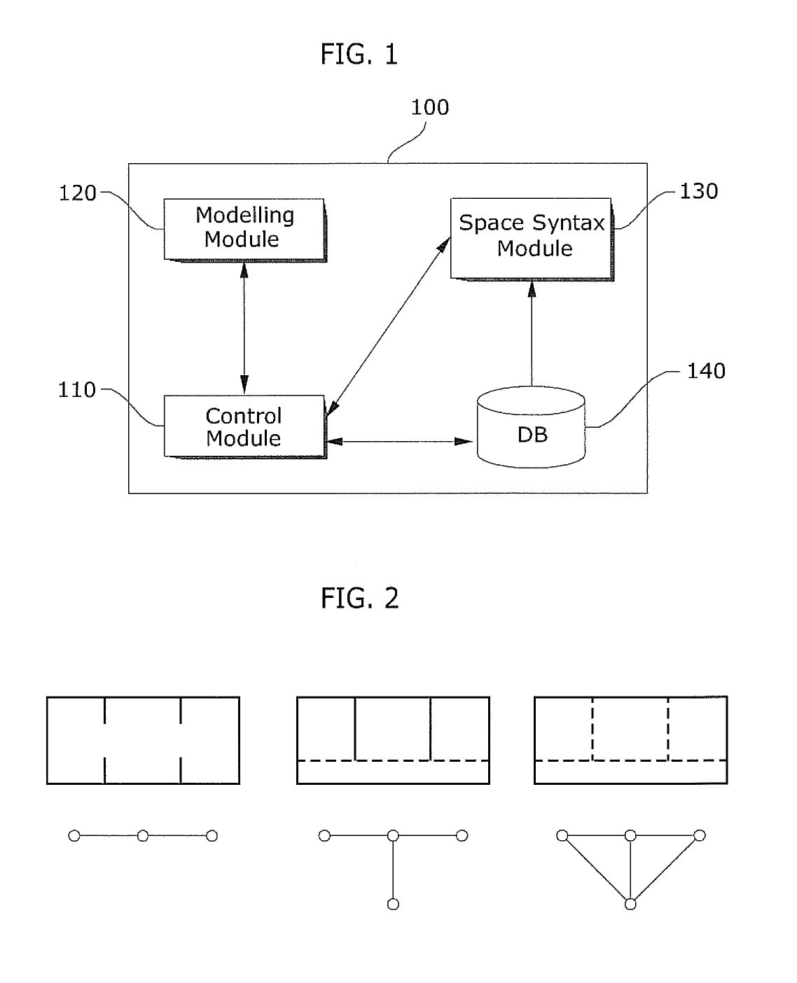

FIG. 1 is a functional block diagram illustrating spatial modelling system in accordance with an embodiment of the present invention.

Referring to FIG. 1, the spatial modelling system 100 includes a control module 110, a modelling module 120, and a space syntax module 130. The spatial modelling system 100 may further include a database (DB) 140.

The constituent elements of the spatial modelling system 100 are represented separately in the drawing to show that they may be functionally and logically separated from each other, and it does not mean that the constituent elements have to be formed as physically separated constituent elements or realized as independent codes.

A predetermined module included in the spatial modelling system 100 may signify a functional and structural combination of hardware for implementing the technological concept of the present invention and software for driving the hardware. For example, it is obvious to those skilled in the art to which the present invention pertains that the module may signify a logical unit of a predetermined code and a hardware resource for implementing the predetermined code, and it does not necessarily mean physically connected codes or one kind of hardware.

The control module 110 may control predetermined other constituent elements of the spatial modelling system 100, e.g., the modelling module 120, the space syntax module 130, and/or the database 140 to realize the technological concept of the present invention.

The modelling module 120 may generate modelling information of a space by receiving an input from a user. The modelling module 120 provides a predetermined interface and makes the user draw a design drawing corresponding to a space, e.g., building and urban environment. Conventional modelling systems are just capable of generating design drawings which are simply formed of points and lines, and they cannot perceive the space signified by the generated design drawings. In other words, the conventional spatial modelling systems for designing a space just perceive a design drawing as a set of points and lines or as a pattern. Therefore, the spatial modelling systems themselves cannot perceive whether a space is formed or not and/or information on the relationship between spaces. Therefore, the conventional spatial modelling systems cannot figure out the information on space syntax of a designed space in real-time while designing, or modelling, the space.

However, the spatial modelling system 100 according to an embodiment of the present invention perceives the space corresponding to a design drawing that is modelled by the spatial modelling system 100. A spatial modelling system capable of perceiving a space is disclosed in Korean Patent Application No. 10-2007-0060641, entitled “Method and apparatus for making architectural space map and automation system using the architectural space map” and filed by the applicant of the present invention. The Korean Patent Application No. 10-2007-0060641 is referred to as a proceeding application, hereafter, and the present specification encloses the technological concept and description disclosed in the proceeding application. Also, the specification of the proceeding application may be incorporated into the specification of the present invention by reference.

As disclosed in the proceeding application, the modelling information of a space that is modelled by the modelling module 120 may be stored in a predetermined format, for example, standard spatial data of the proceeding application, so that the spatial modelling system 100 perceives the space. Therefore, a user of the spatial modelling system 100 may model a predetermined space and simultaneously acquire information on space syntax of the space, which has been modelled up until then. Through the processes, the user refers to predetermined information defined by the space syntax and thereby models the space better or model the space appropriately for the purpose of the space. Modelling information obtained by the modelling module 120 may be stored in the database 140.

The space syntax module 130 may receive the modelling information generated by the modelling module 120 and generate information on space syntax of at least a portion of the space corresponding to the received modelling information. For the space syntax module 130 to generate the information on space syntax, it has to be capable of perceiving what the space corresponding to the modelling information is like. Therefore, it is desirable that the space syntax module 130 is aware of the format that the modelling information generated by the modelling module 120 is stored, and aware of how the format of the information included in the modelling information, the relationship between data, and/or a data structure corresponding to the constituent elements of the space and the relationships thereof. For example, the modelling information may be stored as a standard spatial data that is disclosed in the proceeding application. However, the scope of the present invention is not limited to it, and any system that includes the modelling module 120 capable of performing a modelling operation into a predetermined format in which a space may be perceived, and the space syntax module 130 capable of receiving a design drawing generated by the modelling module 120 and perceiving a space corresponding to the design drawing may be regarded to be included in the technological concept of the present invention. Information on space syntax that is generated by the space syntax module 130 may include diverse parameters related to a space that are dealt in space syntax, which is widely researched for academic purposes. This will be described later on.

The control module 110 may display a space syntax analysis result of at least a portion of the space based on the information on the space syntax analyzed by the space syntax module 130. In short, the control module 110 may display the analyzed information on space syntax through an additional interface, or represents the information on space syntax in a predetermined format on a design drawing generated by the modelling module 120. For example, when the design drawing is a drawing of a building, and the building has a plurality of sub-spaces, the control module 110 may represent information on space syntax that each sub-space has in the sub-space of the design drawing. The control module 110 may differentiate the form, e.g., color, and the thickness of line, representing the information on space syntax. For example, a space with a high integration may be represented in red, while a space with a low integration may be shown in blue among the information on space syntax, which will be described later. Also, for each space, the information on space syntax may be directly represented by a predetermined number, or the shape of a constituent element, e.g., wall or pillar, of a space may be different.

The database 140 may store the modelling information of a space modelled by the modelling module 120. The database 140 may be realized as at least one table, and the database 140 may further include a database management system (DBMS) for searching, storing, and managing the data stored in the database 140. Also, the driving scheme or data structure of the database 140, such as a linked list, tree, and a relational data base, are not restricted. The embodiments of the present invention for realizing the technological concept of the present invention include all kinds of data storage media and data structures that may store information.

As described above, since the spatial modelling system 100 according to an embodiment of the present invention perceives a modelled space and analyzes the information on space syntax based on a predetermined method, it does not require separate space syntax analysis systems and it does not have to perform a process of inputting modelling information again in a form that the space syntax analysis systems perceive, which are necessary in the conventional method.

Meanwhile, the information on space syntax that may be analyzed by the spatial modelling system 100 may include at least one of connectivity, control value, depth, integration, and intelligibility of the space.

FIGS. 2 to 7 illustrate information on space syntax obtained from the analysis of the spatial modelling system in accordance with the embodiment of the present invention.

FIG. 2 shows exemplary spaces and a connectivity graph of the spaces.

In the connectivity graph, each space is represented by a node, and the relationship with a neighboring node is represented by a link or an edge.

The connectivity graph may be usefully used for property analysis of a particular space, and the space syntax module 130 may generate the connectivity graph based on the modelling information generated by the modelling module 120, and store the connectivity graph in the database 140 or an independent storage medium.

Meanwhile, the information on space syntax analyzed by the space syntax module 130 may signify predetermined parameters representing the properties of a space.

The connectivity shows parameters used for morphological analysis, and the parameters may represent the number of nodes directly connected to a node corresponding to a particular space in a connectivity graph.

The control value may be a value represented by the following Equation.

$${ctrl}_{i} = {\sum }_{j = 1}^{k} \frac{1}{{c}_{j}} \qquad Equation 1$$

where k denotes the number of node directly connected to a node I; and [symbol] ⱼ denotes connectivity of a j^{th} directly connected node.

Depth means the number of procedural steps that a person has to go when he/she moves from one node to another node.

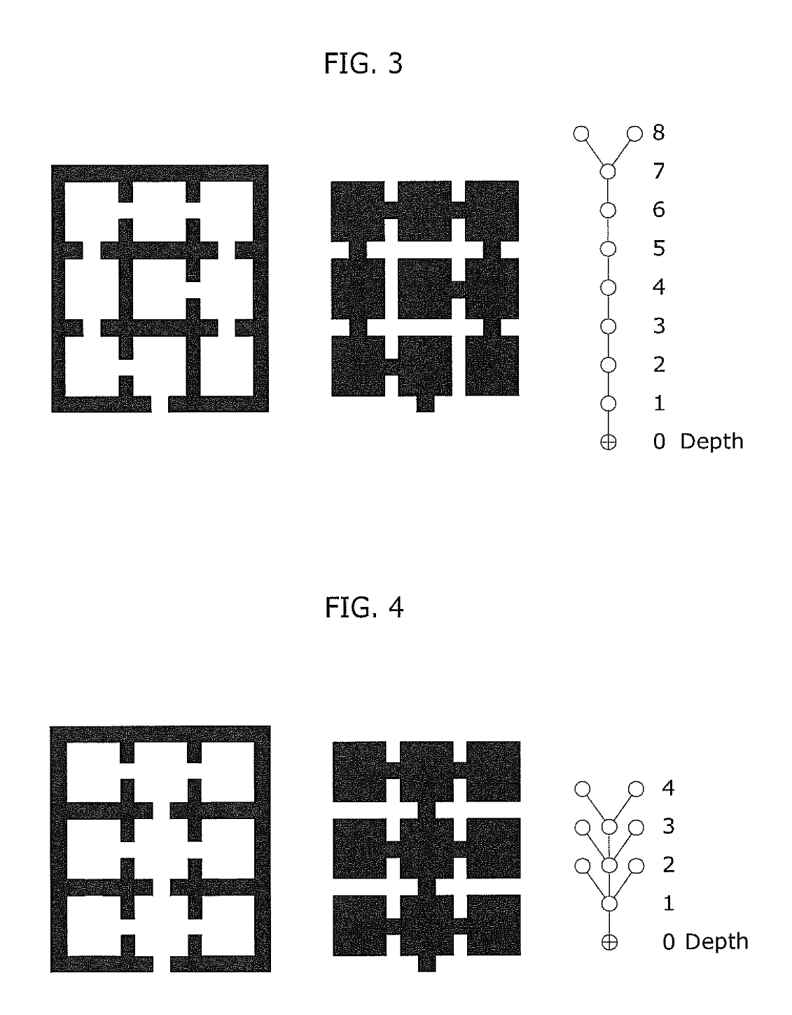

FIGS. 3 and 4 illustrate depth of information on space syntax. Referring to FIG. 3A, the drawing on the left side shows modelling information of a space, and the drawing at the center shows sub-spaces connected to each other. It may be seen from the drawing at the center that any one space, that is, a node, may be connected to another space through many spaces. The drawing on the right side in FIG. 4 shows the connection state of the drawing at the center in the form of connectivity graph. It may be seen from the drawing on the right that the depth of the graph is 8.

Meanwhile, FIG. 4, too, is a drawing for illustrating the depth of a space. In FIG. 4, the drawing on the left represents modelling information, and the drawing at the center shows the connection state, and the drawing on the right is a connectivity graph. It may be seen from FIG. 4 that the depth of the space of FIG. 4 is shallower than the depth of the space of FIG. 3.

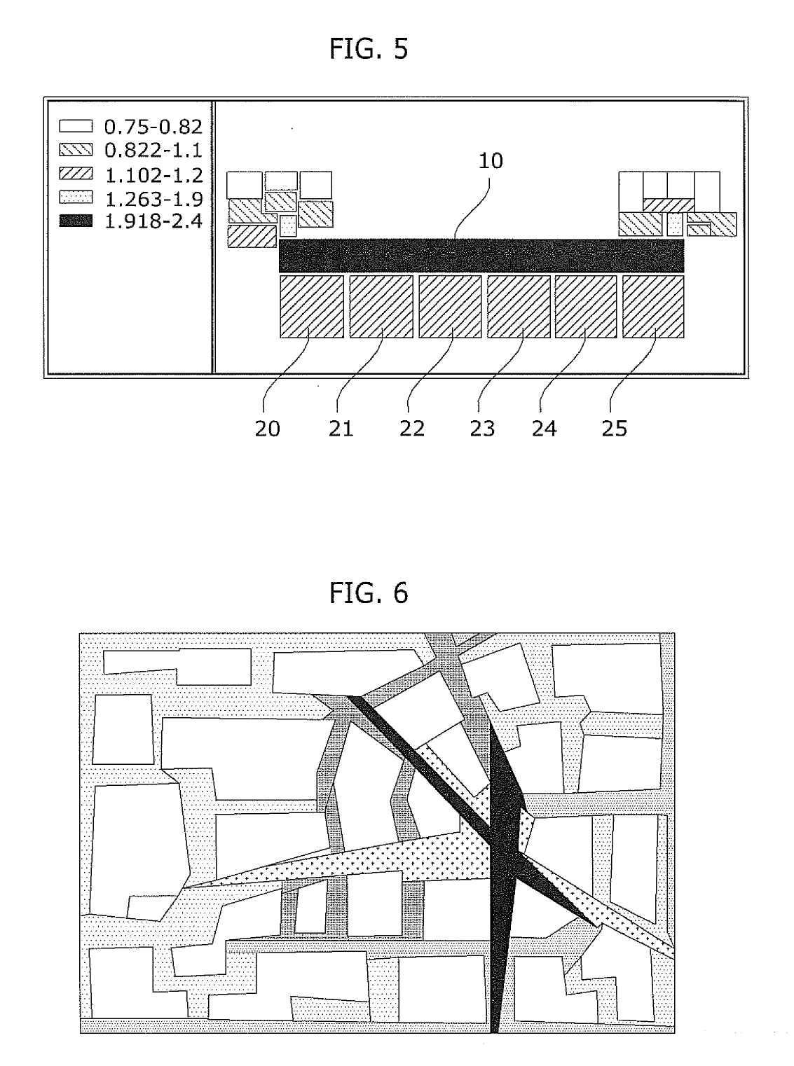

FIG. 5 illustrates integration.

Integration may be a parameter representing how a certain node is integrated with the global area. When a person moves from any one node to another node, as the number of nodes intervening between the two nodes is small, it may be regarded that the integration is high. In other words, a space is said to be more integrated if all the other spaces can be reached after traversing a small number of intervening spaces. Referring to FIG. 5, when a person moves from a space 10 to all the other spaces, there are a few intervening spaces. However, a space 21, a space 22, a space 23, a space 24, and a space 25 have more intervening spaces than the space 10 to reach all the other spaces. Therefore, it may be considered that the space 10 has a higher integration than the spaces 21, 22, 23, 24 and 25. Therefore, the control module 110 marks the space with high integration in a dark color in the design drawing or modelling information of the space illustrated in FIG. 5, whereas marking a space with low integration in a light color so that a user easily figure out the information on space syntax. Also, a study reveals that the integration of a space is closely related to the movement of people. Therefore, when a space designed for many people to go is modelled, a user of the spatial modelling system 100 according to an embodiment of the present invention may model the space while checking his design output in real-time to see whether the space is designed to have an appropriate level of integration.

Intelligibility signifies the extent of understanding the global area based on a predetermined space or portion. In other words, the intelligibility may be a parameter representing the correlation between the geographical properties of a space and/or information on space syntax, e.g., connectivity, and the global properties of a space and/or information on space syntax, e.g., integration.

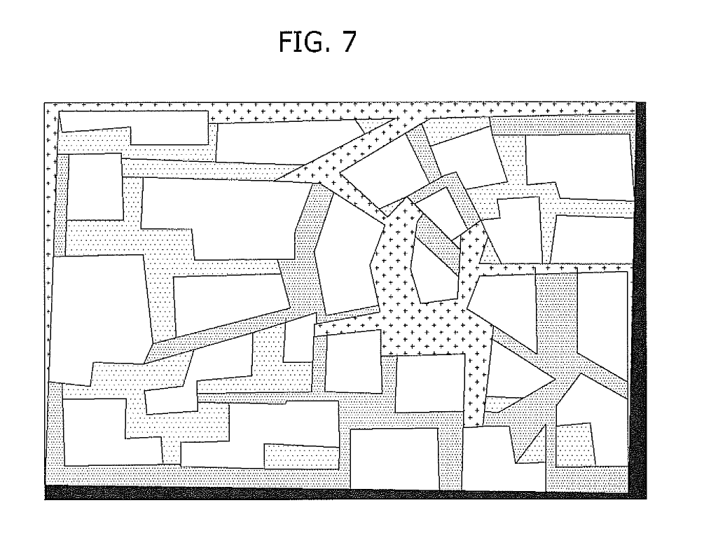

FIGS. 6 and 7 illustrate intelligibility. Herein, the space illustrated in FIG. 6 has a higher intelligibility than the space illustrated in FIG. 7. A study reveals that people find their way more easily in a space with high intelligibility. Also, it is desirable to design a private space or a secret building to have as low intelligibility as possible. Therefore, a user of the spatial modelling system 100 may check a designed space in real-time for whether the intelligibility level of the designed space is appropriate and reflect the intelligibility level into his designing.

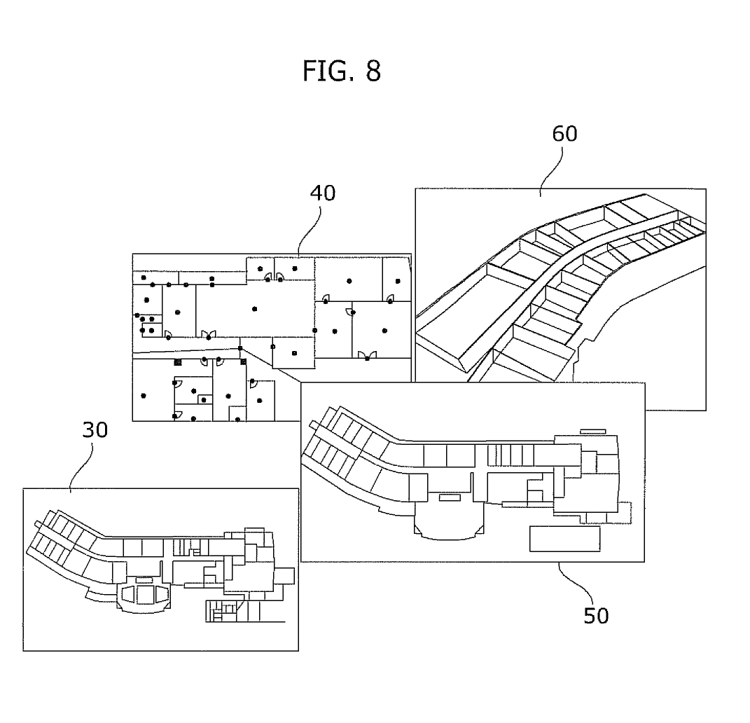

FIG. 8 exemplarily shows screen images obtained after performing a modelling operation in the spatial modelling system in accordance with the embodiment of the present invention.

Referring to FIG. 8, the modelling module 120 of the spatial modelling system 100 may provide a user interface 30 illustrated in FIG. 8, and a user may model, that is, sketch, a space through the user interface 30. The modelling information produced by the modelling module 120 may be perceived by the spatial modelling system 100. In short, as illustrated in a user interface 40, the spatial modelling system 100 figures out the modelling information produced from the modelling by the user, and understands the spaces represented by the modelling information and the relationship between the spaces.

Meanwhile, the modelling information is produced as the user sketches by using the spatial modelling system 100, and the produced modelling information may be represented as a plane space or a three-dimensional stereoscopic space, which is illustrated in user interfaces 50 and 60, respectively. Of course, in order to represent a three-dimensional stereoscopic space based on the modelling information, the user needs to input three-dimensional information, such as the height of a wall while sketching the space. Since a specific example of the technological concept is disclosed in the proceeding application filed by the inventors of the present invention, detailed description on it is omitted herein.

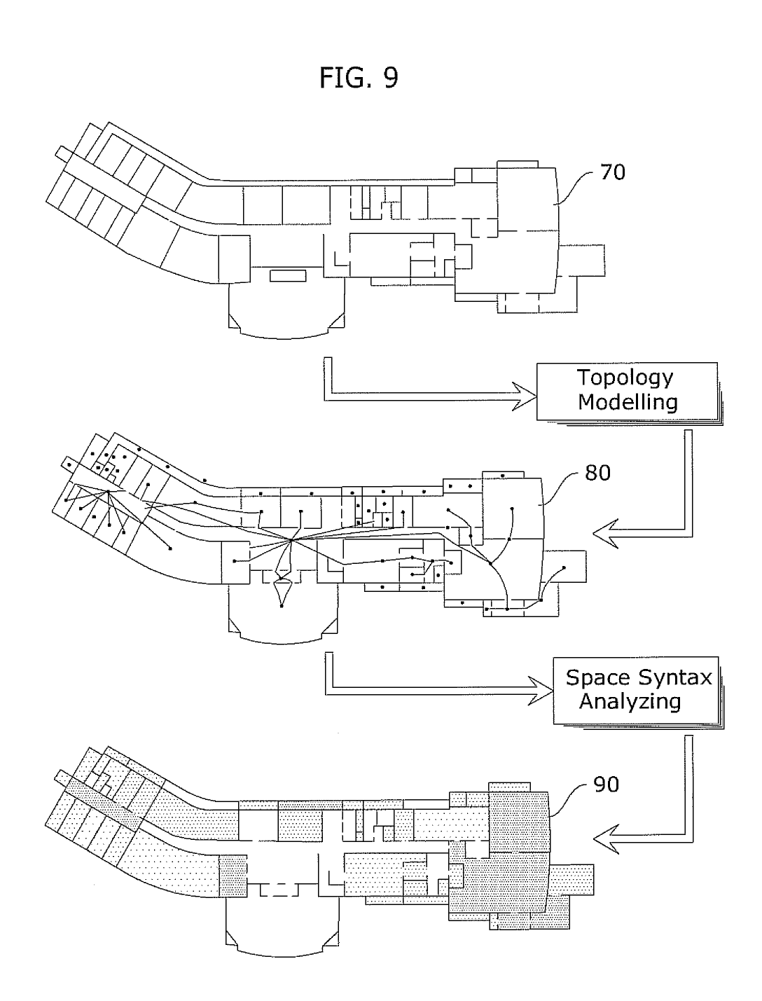

FIG. 9 illustrates a process of analyzing a space based on space syntax in a spatial modelling system in accordance with an embodiment of the present invention.

Referring to FIG. 9, a user may model a predetermined space by using the spatial modelling system 100 to thereby produce modelling information 70. The modelling information 70 is as shown in FIG. 9. The spatial modelling system 100 then figures out the modelling information 70 and understand spaces and the relationship between the spaces. This process may be referred to as a phase modelling process. Information of the phase-modelled space is as shown in FIG. 9. Subsequently, the spatial modelling system 100 figures out the modelling information 70, understands spaces and the relationship between the spaces, and analyzes information on the above-described space syntax based on the relationship between the spaces. The spatial modelling system 100 may display a predetermined space syntax analysis result 90 in the modelling information of the space based on the analysis result, and the result is as shown in FIG. 9. Also, it may be seen from the space syntax analysis result 90 shown in FIG. 9 that display attributes of each space, such as color, may be different according to the value of the analyzed information on space syntax, e.g., connectivity, integration, intelligibility and so forth.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

Since a spatial modelling system in accordance with an embodiment of the present invention is capable of perceiving a modelled space, it does not have to use an independent space syntax analysis tool while performing a modelling operation and to perform an additional operation for a space syntax analysis. Therefore, modelling and space syntax analysis are performed easily.

Also, since the space syntax analysis for a space may be performed instantly as soon as the space is modelled, a user of the spatial modelling system may model the space appropriate for the purpose of the space based on the space syntax analysis result, and efficiently modify the modelling based on the space syntax analysis.

1. A spatial modelling system, comprising:
a modelling module configured to generate a design drawing to represent a space based on input data inputted by a user;
a space syntax module configured to receive the design drawing generated by the modeling module, perceive the space based on the received design drawing, and generate information on space syntax of at least a portion of the space; and
a control module configured to display a space syntax analysis result of the at least one portion of the space based on the information on space syntax generated by the space syntax module.

2. The spatial modelling system of claim 1, wherein the information on space syntax comprises at least one selected from the group consisting of connectivity, control value, depth, integration, and intelligibility.

3. The spatial modelling system of claim 1, wherein the control module displays the space syntax analysis result to have different display attributes according to a value of the information on space syntax.

4. The spatial modelling system of claim 3, wherein the display attributes comprise color.
